(19) United States
(12) Patent Application Publication
(10) Pub. No.: US 2008/0018922 A1
(43) Pub. Date: Jan. 24, 2008

(54) Image processing apparatus, image processing method, and computer-readable medium embodying program

(75) Inventor: Kazuyoshi Tanaka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/825,064

(22) Filed: Jul. 3, 2007

(30) Foreign Application Priority Data
Jul. 21, 2006 (JP) 2006-198848

(51) Int. Cl. G06K 15/02

(52) U.S. Cl. 358/1.11

(57) ABSTRACT

Disclosed is an image processing apparatus including: an image obtaining section to obtain original images to output original image data thereof; a fixed data generating section to generate fixed additional data of a vector font corresponding to fixed additional information to be commonly added to each page, among additional information to be added to the original image data; a fixed data storage section to store the fixed additional data generated; a variable data generating section to generate variable additional data corresponding to variable additional information which varies by page of the original images, among the additional information; an image combining section to combine the fixed additional data and the variable additional data with the original image data to generate composite image data per page; and an image forming section to form images based on the composite image data generated by the image combining section.

### CROSS-REFERENCE TO RELATED APPLICATIONS

The present U.S. patent application claims a priority under the Paris Convention of Japanese patent application No. 2006-198848 filed on Jul. 21, 2006, which shall be a basis of correction of an incorrect translation.

### BACKGROUND

1. Field of the Invention

The present invention relates to an image processing apparatus, an image processing method, and a computer-readable medium embodying a program, and more particularly to an image processing apparatus performing the processing of superimposing peculiar additional information on each image, a method of the image processing, and a computer-readable medium embodying the program for the image processing.

2. Description of Related Art

There has been known an apparatus that superimposes (synthesizes) additional information, such as serial numbers and specific character strings, on each page of original images (document images) to generate image data and prints images of the generated image data. If such additional information is superimposed on an original image, visual appearance of the whole document depends on the style of the additional information.

As for this respect, a technique of generating a easily viewable document image whose layout and style are well-arranged was proposed, in which layout of characters and the like in a table was automatically determined according to the column width or the row height of the table when the table is generated (see, for example, Japanese Patent No. 3111832).

However, the technique described in the Japanese Patent No. 3111832 is simply to adjust the layout of the characters and the like in a table, and the style of the characters per se cannot be arranged.

As the fonts used for documents, there are, for example, a vector font (outline font) which is a font format including the shapes of the contours of characters as the information of function curve, a bitmap font (dot font) which expresses characters with combinations of dots, and the like.

The bitmap font has a feature of a short processing time from the generation of data to the output (printout) of the data, although the font cannot arrange the style of characters.

On the other hand, the vector font (outline font) has features that rasterizing processing is need to be performed, which converts outline data into bitmap data, in order to output (printout) it, and the rasterizing processing takes a lot of time. However, because the contours of characters are smooth and kerning processing, which adjusts character spacing, can be performed, the vector font has a feature of enabling characters and layouts that are superior in design and expressivity.

Accordingly, in order to arrange the styles of characters per se to generate high quality document images excellent in design and expressivity, it is preferable to generate data of the additional information with the vector font (outline font).

However, in the case of superimposing additional information on an original image, the superimposing processing of the additional information onto the original image document is performed between printing pages. Consequently, it is desired to generate the data of the additional information at a high speed. If the data of the additional information is generated using the vector font (outline font), an output speed such as printing a document slows down and the productivity is deteriorated. Consequently, the data of additional information has been generally generated using a bitmap font having a monospaced pitch.

FIG. 6 shows an example of additional information generated using the bitmap font. The dotted lines in the figure show the positions where characters are arranged. In the case of generating the data of the additional information using the bitmap font, the generation of the data does not take a lot of time, and consequently it is possible to output the data at a high speed to improve productivity. However, as shown in FIG. 6, the character spacing of a character string by the bitmap font cannot be adjusted, and the layout of the character string is to be a monospaced pitch layout, in which all characters are arranged at regular intervals. Consequently, in a character string of “WAYXZ” for example, there are gaps between each character of the part of “WAY” and contrary, the characters of the part of “XZ” are packed. Thus, the layout makes it hard to read. Moreover, the bitmap font cannot enable flexible expression of characters excellent in design and expressivity.

Now, in the additional information that is superimposed on the document, there are generally additional information common to the whole document (all pages), such as the name of a company and a case number, and additional information that varies by page of a document, such as a page number and a serial number. Between them, the additional information that varies by page of the document is often composed of only figures of a serial number, a page number, and the like, and does not so much influence the style of the whole document. On the other hand, the additional information common to the whole document (all pages), such as the name of a company, influences the style of the whole document. If the design and the layout of these characters are not arranged well, it is problematic that a high quality document excellent in visual appearance cannot be formed. On the other hand, some recent copier and printer can perform copying/printing 100 sheets or more per minute. If such high speed machines generate the entire additional information with the vector font, the machines are obliged to hold during rendering processing for expanding the additional information into bitmap data, and a problem of decreasing productivity is caused.

### SUMMARY

The present invention was made in order to settle the problems mentioned above, and aims to provide an image processing apparatus and an image processing method that can generate a high quality document excellent in visual appearance without reducing the productivity thereof in the case of superimposing additional information on an original image, and a computer-readable medium embodying a program enabling such an apparatus and a method.

To achiever at least one of the above objects, according to an image processing apparatus reflecting one aspect of the present invention, comprises: an image obtaining section to obtain original images to output original image data thereof; a fixed data generating section to generate fixed additional data of a vector font corresponding to fixed additional information to be commonly added to each page of the original images, among additional information to be added to the original image data; a fixed data storage section to store the fixed additional data generated by the fixed data generating section; a variable data generating section to generate variable additional data corresponding to variable additional information which varies by page of the original images, among the additional information to be added to the original image data; an image combining section to combine the fixed additional data and the variable additional data with the original image data to generate composite image data per page of the original images; and an image forming section to form images based on the composite image data generated by the image combining section.

Preferably, the variable data generating section generates the variable additional data of a bitmap font.

Preferably, the image processing apparatus may further comprises a data storage section to store previously generated basic data, wherein the variable data generating section extracts basic data corresponding to the variable additional information from the basic data stored in the data storage section, so as to generate the variable additional data.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram of the principal part showing a schematic configuration of an image processing apparatus according to the present embodiment;

FIG. 2 is a view showing an example of a stamp selecting screen;

FIG. 3 is a view showing an example of a stamp position setting screen;

FIG. 4 is a view showing an example of combining fixed additional information generated using an outline font and variable additional information generated using a bitmap font;

FIG. 5 is a flow chart showing the flow of composite image data generating processing in the image processing apparatus of the present embodiment; and

FIG. 6 is a view showing an example of combining fixed additional information and variable additional information that are generated using a bitmap font.

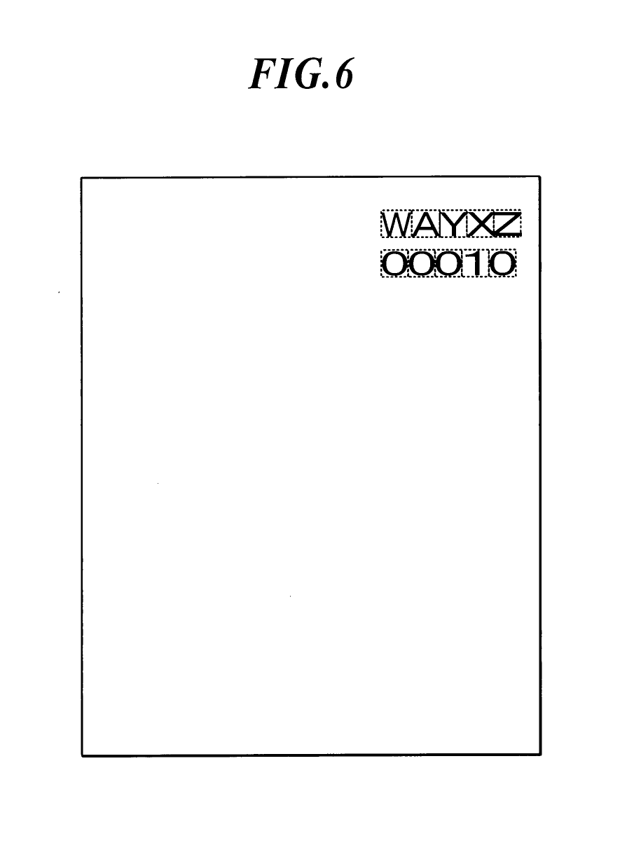

### DETAILED DESCRIPTION OF THE PREFERRED EMBODIMENTS

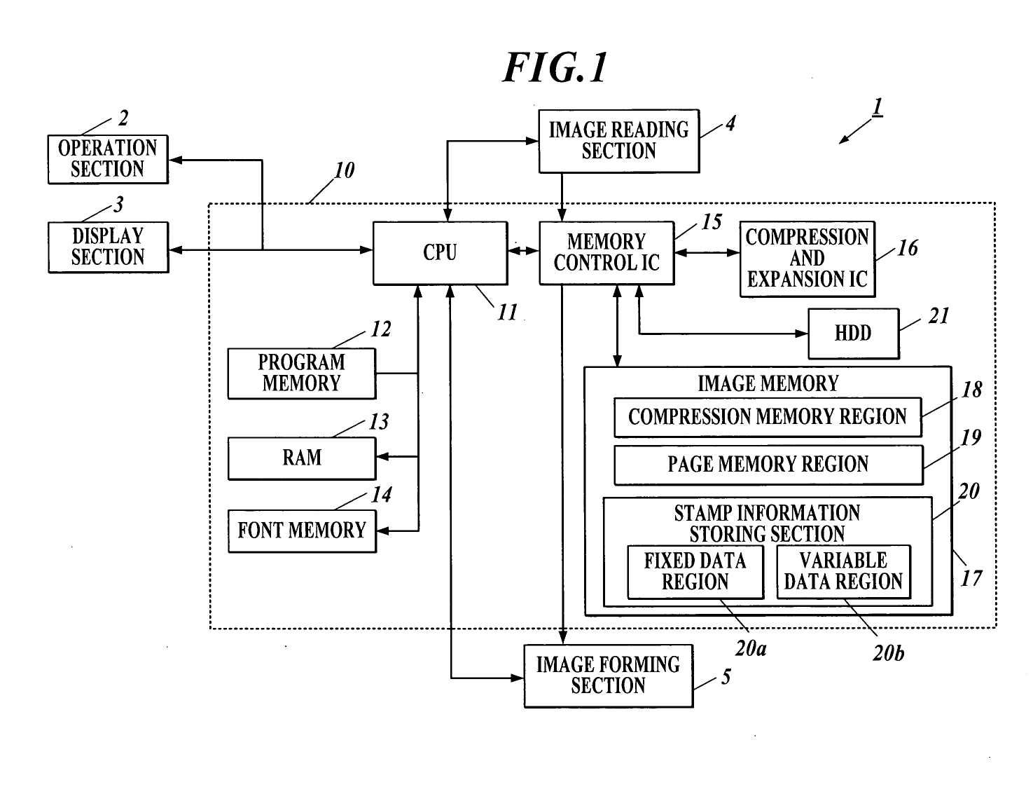

In the following, an embodiment of each of an image processing apparatus, an image processing method, and a program stored in a computer-readable medium according to the present invention will be described with reference to FIGS. 1-5. However, the scope of the invention is not limited to the shown examples.

First, the configuration of an image processing apparatus 1 of the present embodiment is described with reference to FIG. 1. The image processing apparatus 1 of the present embodiment is, for example, a multi function peripherals (MFP), and the image processing apparatus 1 includes an operation section 2, a display section 3, an image reading section 4, an image forming section 5, and a state managing section 10, which wholly controls the other sections.

The operation section 2 functions as a setting section that a user inputs various instructions to set various selection settings. The operation section 2 is composed of various operation buttons (not shown) such as numeric buttons, function buttons for switching various settings and operational modes, and a start button for instructing a start of operation. In the present embodiment, a user can perform, for example, the selection of adding additional information to a document (original image), the selection of the kind of the additional information to be added, the selection and input of the content (a character string and the like) to be added as the additional information, and the like by operating the operation section 2. The operation section 2 is configured to output the operation signal input by the user to a CPU 11, which will be described later.

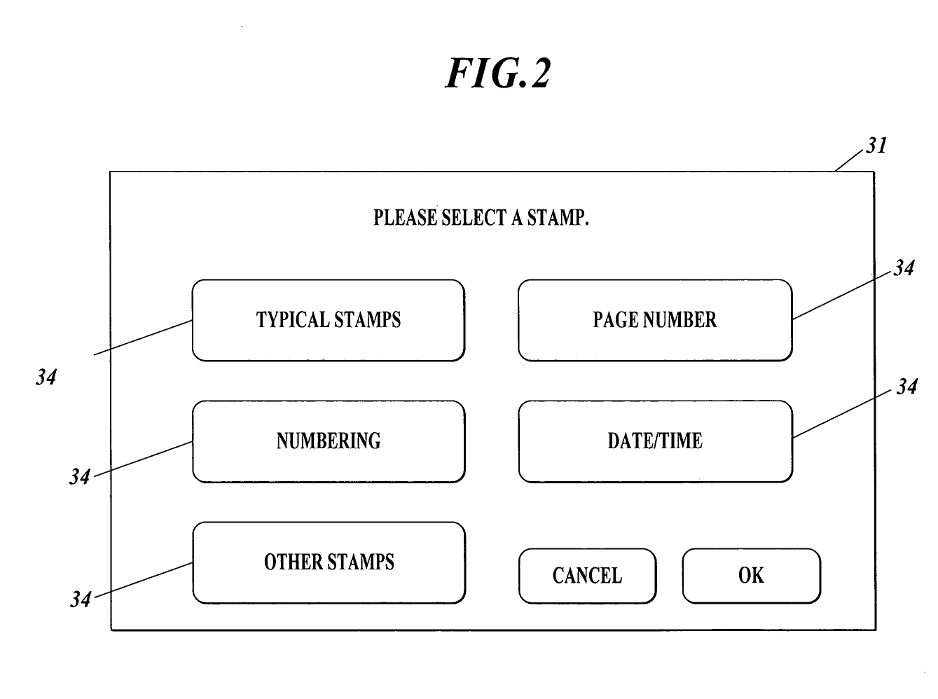

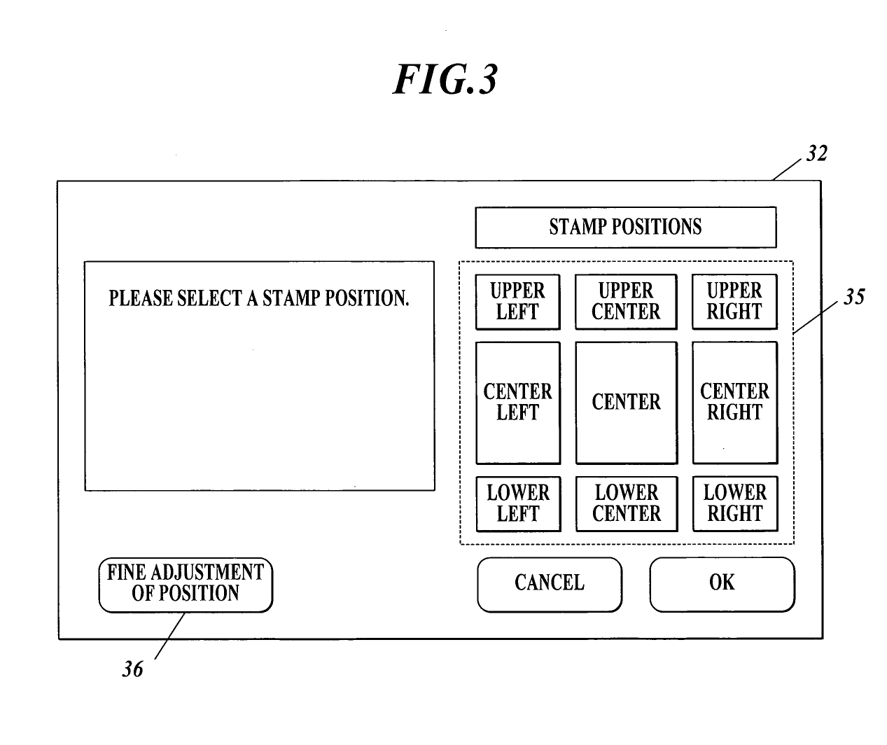

The display section 3 is composed of, for example, a liquid crystal display (LCD), a cathode ray tube (CRT) display, an electroluminescence (EL) display, or the like. The display section 3 displays various operation screens, such as a setting screen of setting conditions, the state of an image, the operation state of each function, various kinds of processing results, and the like in conformity with instructions of display signals input from the CPU 11, which will be described later. In the present embodiment, the display section 3 is configured to be able to display, for example, a stamp selecting screen 31 (FIG. 2) for specifying the format of a stamp (hereinafter referred to as “stamp format”), a stamp position setting screen 32 (FIG. 3) for specifying a region to which a stamp is added (hereinafter referred to as “stamp position”), and the like as the additional information.

Incidentally, a pressure sensitive (resistive film pressure sensitive) touch panel (not shown) composed of transparent electrodes arranged in a reticular pattern may be formed on the screen of the display section 3 to be a touch screen composed of the display section 3 and the operation section 2 that are integrally configured. The touch panel is configured to detect the X-Y coordinates of a power point depressed by a finger or a touch pen as voltage values, and to output the detected position signals to the CPU 11 as operation signals. In this case, the display section 3 functions as the setting section together with the operation section 2. In the present embodiment, the case where the image processing apparatus 1 is provided with the touch screen composed of the display section 3 and the operation section 2 that are integrally configured will be described as an example.

In the present embodiment, “typical stamps,” “page number,” “numbering,” “date/time,” and “other stamps” are selectable as the additional information.

If the stamp selecting screen 31 is displayed on the display section 3 by an operation of a user, then setting buttons 34 for selecting a stamp format such as the “typical stamps,” the “page number,” the “numbering,” the “date/time,” or the “other stamps” are displayed on the display section 3 as shown in FIG. 2, and the user can select a stamp format by depressing the setting button 34 of a desired stamp format.

The “typical stamps” is the function of giving previously prepared typical characters and the like as stamps.

Character strings, marks, and the like such as “for internal use only,” and “important” that are frequently given as the additional information of documents are previously set and registered, and the function of the “typical stamps” enables the selection and the setting of a desired stamp among the registered stamps.

The “page number” is the function of giving a page number to each page of a document (original image) as a stamp. The page number is given to each page of the document as a consecutive number.

The “numbering” is the function of giving figures in the order of original images as stamps, and can be used as consecutive numbers given to exhibits in a discovery procedure in a court of law in U.S.

The “date/time” is the function of giving the date and the time when an original is read as a stamp [symbol] .

Moreover, the “other stamps” is the function of enabling a user to specify an arbitrary character string or a mark that is not set as one of the typical stamps to give the specified character or the mark as a stamp. For example, when the user operates the “other stamps” button 34, the display screen of the display section 3 changes to the input screen (not shown) of a stamp, and the user inputs an arbitrary character string, a mark, or the like that the user wants to give it as a stamp from the input screen.

As the additional information set as the “other stamps,” for example, the name of a company, the name of a department, a Uniform Resource Locator (URL), a case number, and the like can be cited, but the “other stamps” are not limited to those. Incidentally, the image processing apparatus 1 may be configured so that the content that was once input as one of the “other stamps” is saved (stored) in, for example, a fixed data region 20a of a stamp information storing region 20, which will be described later, and that the content can be selected as an existing stamp after that so as not to need the re-input by the user.

Incidentally, the “typical stamps,” the “date/time,” and the “other stamps” among those stamps are the fixed additional information, the same content of each of which is commonly given to all the pages of a document including a plurality of pages, and the “page number” and the “numbering” are the variable additional information, the content of each of which varies by page.

Next, on the stamp position setting screen 32, for example, stamp position specifying buttons 35 are displayed on the display section 3 as shown in FIG. 3. The stamp position setting screen 32 is configured so that a user selects a desired stamp position to depress any one of the stamp position specifying buttons 35, and that the stamp position is specified among nine positions of “upper left,” “center left,” “lower left,” “upper center,” “center,” “lower center,” “upper right,” “center right,” “lower right” positions. For example, if the user specifies the “upper right” as the stamp position, a stamp is superimposed in the upper right region of an original image.

Moreover, if the user depresses a fine adjustment of position button 36 for the fine adjustment of a stamp position on the stamp position setting screen 32, a not shown fine adjustment setting screen is displayed on the display section 3. The fine adjustment mechanism enables the user to perform the fine adjustment by depressing numeric keys on the fine adjustment setting screen to shift the position of a stamp by, for example, 0.1 mm in each of the vertical direction and the horizontal direction.

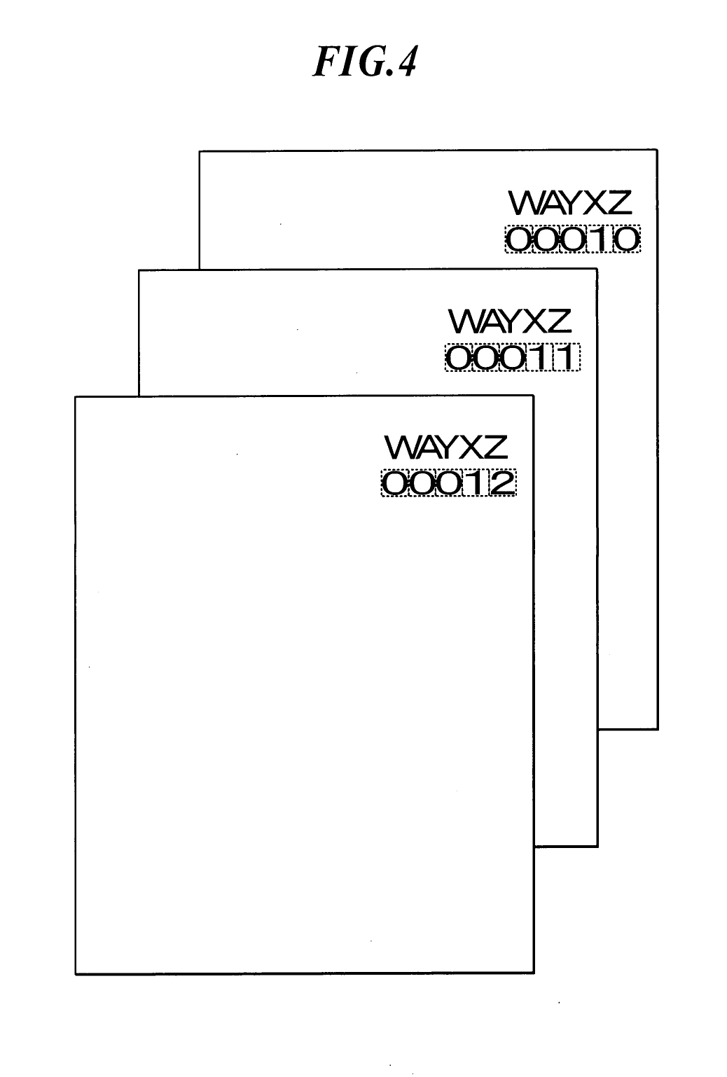

Incidentally, a plurality of stamps can be selected as additional information. For example, if a user selects the “other stamps” and the “numbering” as stamps and inputs the “WAYXZ” as the “other stamps,” then the “WAYXZ” and the number given to each page (for example, “00010,” “00011,” “00012,” . . . ) are laid out in two steps (see, for example, FIG. 4).

Incidentally, the layout in the case where a plurality of stamps is selected is not limited to the one illustrated here. For example, if the “typical stamps” and the “numbering” are selected, the “typical stamps” may be disposed at the upper right position of a document, and each number of the “numbering” may be disposed at the lower right position of the document. By such a way, the stamp position of each of the selected plurality of stamps may be separately set to dispose each stamp at a different position in the document.

Next, the image reading section 4 reads an image recorded on an original to generate the monochrome (binary or multilevel including monochrome intermediate values) image data (original image data) of the image. The image reading section 4 includes a light source radiating light onto an original, an image sensor using a charge coupled device (CCD), a complementary metal-oxide semiconductor (CMOS), or the like for photoelectrically converting the reflected light from the original, a scanning section moving the light radiated to the original, and an image processing section performing various kinds of conversion processing to an electric signal read by the image sensor to output image data (original image data) (all of the sections are not shown). The image reading section 4 is configured to perform the reading of an image in conformity with an instruction signal from the CPU 11.

The image forming section 5 is a printer of, for example, an ink jet type, an electrophotographic type, a thermal transfer type, a dot-impact type, or the like. The image forming section 5 forms and records an image on a recording medium such as recording paper based on the image data obtained by the image reading section 4 or the like in conformity with an instruction signal from the CPU 11.

Next, the state managing section 10 is a computer including the CPU 11, a program memory 12, a random access memory (RAM) 13, a font memory 14, a memory control IC 15, a compression and expansion IC 16, an image memory 17, a hard disk drive (HDD) 21, and the like.

The program memory 12 is a nonvolatile memory made of, for example, a semiconductor, and stores a system program corresponding to the image processing apparatus 1, various kinds of processing programs such as various application programs executable on the system program, the data pertaining to the processing of the programs, and the like. The programs are stored in the form of program codes readable by a computer, and the CPU 11 sequentially executes the operations in accordance with the program codes.

In the present embodiment, the program memory 12 stores a composite image data generating program. The composite image data generating program is a program for generating fixed additional data corresponding to the fixed additional information and variable additional data corresponding to the variable additional information (fixed data generating processing and variable data generating processing, respectively) as the peculiar additional information to be added to each page of the image data (original image data) obtained by the image reading section 4, and for combining these fixed additional data and variable additional data with the original image data to generate composite image data of each page (image combining processing).

The RAM 13 is used as a temporary storage region of a program read from the program memory 12, input data, output data, parameters, and the like in various kinds of processing executed and controlled by the CPU 11.

The font memory 14 is a nonvolatile memory made of, for example, a semiconductor or the like, and stores the font data of the vector font (the outline font), the bitmap font, and the like. Incidentally, the font data of the bitmap font may be stored in a compressed form. The font memory 14 supplies the font data for generating the data of each additional information to the CPU 11 when the CPU 11 generates the fixed additional data corresponding to the fixed additional information and the variable additional data corresponding to the variable additional information in fixed data generating processing and variable data generating processing, which are executed by the CPU 11.

The CPU 11 performs the central control of each section in the image processing apparatus 1. The CPU 11 reads a specified program from the system program and the various application programs that are stored in the program memory 12 to expand the read program in the RAM 13, and executes various kinds of processing in cooperation with the program expanded in the RAM 13.

The memory control IC 15 controls the compression and expansion IC 16 to compress the image data (original image data) input from the image reading section 4 and composite image data under the control of the CPU 11, and write the compressed image data (original image data) and composite image data into a compression memory region 18 of the image memory 17 to make the compression memory region 18 store the data. Moreover, when the CPU 11 instructs the output of image data, the memory control IC 15 controls the compression and expansion IC 16 to expand the image data (original image data) and the composite image data that are stored in the compression memory region 18, and writes the expanded data into a page memory region 19 to make the page memory region 19 temporarily store the expanded data. Then, the memory control IC 15 sequentially outputs the image data (original image data) and the composite image data in each page to the image forming section 5.

Moreover, the memory control IC 15 suitably transfers the composite image data generated by an image combining section, which synthesizes original image data and the data (the fixed additional data and the variable additional data) of additional information, to the compression memory region 18, and makes the compression memory region 18 stored the composite image data. Moreover, the memory control IC 15 suitably transfers the original image data, the composite image data, and the like to the HDD 21, which will be described later, and makes the HDD 21 store the transferred data. Incidentally, the composite image data generated by the image combining section is the data of the original image data and the data (the fixed additional data and the variable additional data) of the additional information that are associated with each other per page of the image.

The compression and expansion IC 16 is an IC performing the compression processing and expansion processing of the image data (original image data) and the composite image data under the control of the memory control IC 15.

The image memory 17 is formed of, for example, a dynamic random access memory (DRAM), and includes the compression memory region 18, the page memory region 19, and the stamp information storing region 20.

The compression memory region 18 stores image data compressed by the compression and expansion IC 16 under the control of the memory control IC 15. In the present embodiment, the compression memory region 18 stores original image data and composite image data generated by combining the original image data and the data (the fixed additional data and the variable additional data) of additional information. The composite image data is stored in the compression memory region 18 in the state in which the original image data and the data (the fixed additional data and the variable additional data) of the additional information are associated with each other per page of the image. The page memory region 19 stores the image data expanded by the compression and expansion IC 16 by page.

The stamp information storing region 20 is a storage section storing the information of various stamps added to original image data as the data (the fixed additional data and the variable additional data) of additional information in the present embodiment. As the formats of stamps, there are the “typical stamps,” the “page number,” the “numbering,” the “date/time,” the “other stamps,” and the like as described above, but the stamp formats are not limited to these illustrated ones.

The stamp information storing region 20 includes the fixed data region 20a for storing the data (fixed additional data) of fixed additional information, the same contents of which are commonly given to all the pages of a document including a plurality of pages, such as the “typical stamps,” the “date/time,” and the “other stamps,” and a variable data region 20b for storing the data (variable additional data) of variable additional information, the contents of which varies by page, such as the “page number,” and the “numbering.” Moreover, the fixed data region 20a saves (stores) the character information, which is the basis of character strings constituting the “typical stamps,” the “date/time,” and the like of the fixed additional information, and the variable data region 20b saves (stores) the character information, which is the basis of character strings constituting the “page number,” the “numbering,” and the like of the variable additional information.

In the present embodiment, when the fixed additional information is selected as the additional information to be added to original image data, if it is, for example, the “typical stamps,” or the “date/time,” the CPU 11 obtains the character information of the basis of the character strings constituting the fixed additional information from the fixed data region 20a, and if it is the “other stamps,” the CPU 11 obtains the character information input from the operation section 2 or the like. Furthermore, the CPU 11 reads the font data of the vector font (outline font) from the font memory 14, and generates the data (fixed additional data), such as a character string and a mark, that constitutes the additional information.

That is, the CPU 11 generates the vector font (outline font) data such as the character string and the mark constituting the additional information from the font data stored in the font memory 14, and performs kerning processing, which adjusts character spacing and the like, and the like. After that, the CPU 11 performs rasterizing processing converting the vector font (outline font) into bitmap data, which is the data capable of being output for printing or the like. Incidentally, it is preferable to suitably perform rendering by, for example, generating hinting information from the vector font (outline font) data to perform the conversion into the bitmap data based on the hinting information at the time of performing rasterizing processing. Consequently, it is possible to generate the fixed additional data composed of high quality character strings excellent in visual external appearances, each character of which character strings has a smoother contour.

On the other hand, when the variable additional information is selected as the additional information added to the original image data, the CPU 11 obtains the character information of the basis of the character strings constituting variable additional information from the variable data region 20b, and reads the font data of the bitmap font from the font memory 14 to generate the data (variable additional data) such as a character string and a mark constituting the additional information.

FIG. 4 is a view illustrating the case where fixed additional information is generated using the vector font (outline font) and variable additional information is generated by bitmap font when adding the “WAYXZ” as the fixed additional information is selected and input from the operation section 2 or the like and adding the numbering in order from “00010” as the variable additional information is selected and input from the operation section 2 or the like.

In the case where the fixed additional information is generated using the vector font (outline font) and the variable additional information is generated using the bitmap font like the present embodiment, the part where character spacing is too much large in the case of the monospaced pitch like the “WAY” part, for example, can be adjusted by performing the kerning processing of narrowing the character spacing to prevent the character spacing from being too much large, and contrary the part where character spacing is too much small in the case of the monospaced pitch like the “XZ” part can be adjusted by performing the kerning processing of widening the character spacing to prevent the character spacing from being too much small, as to the fixed additional information. Consequently, the character string is laid out to have a high quality to be easy to read and to be excellent in design performance and visual external appearance.

Incidentally, in the case of the variable additional information, such as the “page number,” and the “numbering,” of a changing character string, mark, or the like to be given, the basic character data, mark data and the like of the additional information to be given are stored in the variable data region 20b. Then, the CPU 11 operates the data of the characters and the like, and reads font data from the font memory 14 based on the operation results. The CPU 11 then generates the data (variable additional data) of the character string, the mark, or the like that constitutes the stamp, and the generated data is stored in the variable data region 20b.

In order to associate the variable additional information, which varies by page, to each page of an original image in order, the stamp information storing region 20 is provided with, for example, a not shown counter to gasp the figure to be given to each piece of original image data. Incidentally, in the case of determining the figure to be given to each piece of the original image data by the counter, the counter may be configured to automatically reset its figure every fixed end such as every image forming job, or may be configured to continuously count the figures over jobs.

In the present embodiment, the CPU 11 reads the data, such as a character string constituting additional information from the fixed data region 20a and the variable data region 20b of the stamp information storing region 20, and reads font data stored in the font memory 14 to generate the fixed additional data corresponding to the fixed additional information and the variable additional data corresponding to the variable additional information. That is, the CPU 11, the font memory 14, and the fixed data region 20a of the stamp information storing region 20 constitute a fixed data generating section generating the fixed additional data; and the CPU 11, the font memory 14, and the variable data region 20b of the stamp information storing region 20 constitute a variable data generating section generating variable additional data. Moreover, the fixed data region 20a functions as a fixed data storage section storing the fixed additional data generated by the fixed data generating section.

Moreover, in the present embodiment, the CPU 11 controls the memory control IC 15 and the image memory 17 in cooperation with the composite image data generating program expanded in the RAM 13, and the CPU 11, the memory control IC 15, and the image memory 17 thereby function as the image combining section combining original image data with the fixed additional data corresponding to fixed additional information and the variable additional data corresponding to variable additional information.

The HDD 21 is a saving storage section for saving original image data, composite image data and the like. In the present embodiment, the compression memory region 18 is used as a buffer, and original image data and the data of additional information are superimposed on each other. Thus composite image data is compressed to be once stored in the compression memory region 18 of the image memory 17. After that, the compressed composite image data is transmitted to the HDD 21 as the saving storage section, and is stored to be accumulated in the HDD 21. As mentioned above, the image processing apparatus 1 is provided with the HDD 21 as the saving storage section in addition to the compression memory region 18, and the image processing apparatus 1 can thereby save much original image data and composite image data in comparison with the case where the compression memory region 18 is used as the saving storage section.

Incidentally, although the HDD 21 is built in the image processing apparatus 1 in the present embodiment, the HDD 21 may be provided in the outside of the apparatus 1. Moreover, the HDD 21 is not an essential constituent element of the image processing apparatus 1, but the image processing apparatus 1 can be configured not to be provided with the HDD 21.

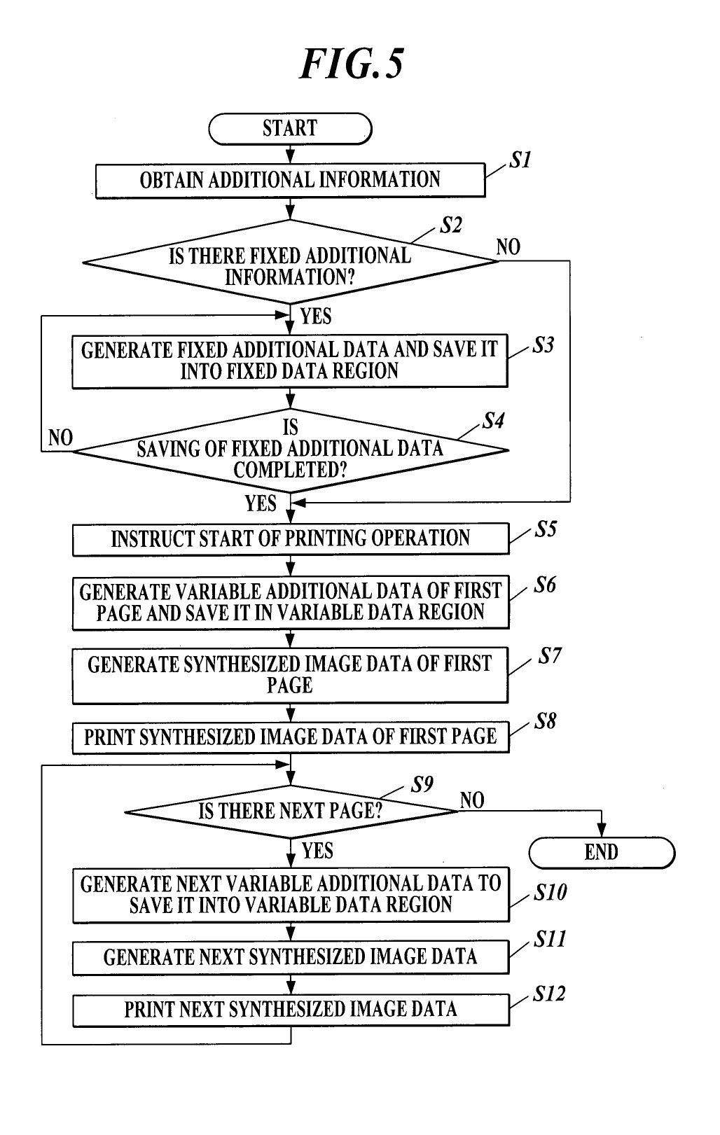

Next, an image processing method by the image processing apparatus 1 in the present embodiment will be described with reference to FIG. 5. Incidentally, the composite image data generating processing described in the following is realized by the cooperation of the computer composed of the CPU 11 and the like and the composite image data generating program.

First, a user selects the composite image data generating processing with the touch panel or the like as the operation section 2, and thereby the composite image data generating processing is started. In the case of performing the composite image data generating processing, a user selects a format of the additional information (stamp) to be combined with original image data and a position where the stamp is superimposed from, for example, the stamp selecting screen 31 (see FIG. 2), the stamp position setting screen 32 (see FIG. 3) and the like of the display section 3, which is also used as the operation section 2, as described above. Thereby, the additional information (stamp) to be added to the original image is obtained (step S1).

On the other hand, the original image data obtained by the image reading section 4 is stored in the page memory region 19 of the image memory 17 through the memory control IC 15.

The CPU 11 judges whether the selected additional information includes fixed additional information or not (step S2). When the selected additional information includes the fixed additional information (step S2: YES), the CPU 11 generates the fixed additional data corresponding to the fixed additional information, and saves (stores) the generated fixed additional data into the fixed data region 20a of the stamp information storing region 20 (step S3).

That is, the CPU 11 obtains the character information of the basis of the character string selected as the fixed additional information from the fixed data region 20a (incidentally, in the case of the “other stamps”, the CPU 11 obtains the information of the character string input from the operation section 2 or the like), and reads vector font (outline font) data from the font memory 14 to generate the outline data of the fixed additional information. Then, the CPU 11 performs rasterizing processing to the outline data, and converts the outline data into bitmap data capable of being output to a printer to generate fixed additional data.

The CPU 11 judges whether the fixed additional data has been saved into the fixed data region 20a or not (step S4). If the saving of the fixed additional data has not been completed (step S4: NO), the CPU 11 returns the processing to that at the step S3, and performs the generation and saving processing or the fixed additional data. If the saving of the fixed additional data into the fixed data region 20a has been completed (step S4: YES), the CPU 11 outputs an instruction signal instructing the start of printing (output) to the memory control IC 15, the image forming section, and the like (step S5). Incidentally, if the selected additional information does not include any fixed additional information (step S2: NO), the CPU 11 does not perform the processing of the generation of the fixed additional data, and outputs the instruction signal instructing the start of printing (output) to the memory control IC 15, the image forming section, and the like (step S5).

Moreover, the CPU 11 obtains the character information of the basis of the character string constituting the variable additional information from the variable data region 20b of the stamp information storing region 20, and reads a bitmap font from the font memory 14 to generate the variable additional data corresponding to the variable additional information toe be added to the first sheet of the document. Then the CPU 11 saves (stores) the variable additional data into the variable data region 20b of the stamp information storing region 20 (step S6).

The CPU 11 reads fixed additional data from the fixed data region 20a, and reads variable additional data to be added to the first page (first sheet) of the document (original image) from the variable data region 20b. The CPU 11 then performs the synthetic processing of image data that superimposes the fixed additional data and the variable additional data on the original image data in the first page (first sheet) stored in the page memory region 19 at the positions selected by the operation section 2, and generates composite image data (step S7). Then, the CPU 11 performs the printing (output) of the first sheet of the document (original image) from the image forming section 5 based on the generated composite image data (step S8).

The CPU 11 judges whether the document has the next page (second sheet) or not (step S9). If the document has the next page (step S9: YES), the CPU 11 obtains the character information of the basis of the character string constituting the variable additional information from the variable data region 20b, and determines a figure (“2” in case of the second sheet) to be given to the original image data with the counter. Moreover, the CPU 11 reads the bitmap font from the font memory 14, and generates the variable additional data corresponding to the variable additional information to be added to the next page to save (store) the variable additional data into the variable data region 20b (step S10).

Then, the CPU 11 reads the fixed additional data from the fixed data region 20a, and reads the variable additional data to be added to the second page (second sheet) of the document (original image) from the variable data region 20b. The CPU 11 performs the synthetic processing of the image data that superimposes the fixed additional data and the variable additional data on the original image data of the second page (second sheet) stored in the page memory region 19 at the positions selected by the operation section 2, and generates composite image data (step S11). Then, the CPU 11 performs the printing (output) of the second sheet of the document (original image) by the image forming section 5 based on the generated composite image data (step S12).

Since then, the CPU 11 similarly judges whether the document has the next page or not. If the document has the next page, the CPU 11 repeats the processing at the steps S10-S12. On the other hand, if the document has not the next page (step S9: NO), the CPU 11 ends the generation processing of the composite image, and image forming processing.

As described above, according to the present embodiment, if additional information is added to the original image data obtained by the image reading section 4, the data of fixed additional information, which is common to all pages, is generated using a high quality vector font (outline font) excellent in visual external appearance; and the data of variable additional information, which varies by page, is generated by a bitmap font, which can perform high speed data generation. Thereby, the present embodiment can deal with high speed printing output, and can produce a high quality document the whole style of which is in good order.

Moreover, in order to generate outputting (printing) data of the vector font (outline font), rasterizing processing must be performed, and the processing takes a lot of time. However, in the present embodiment, because only the fixed additional information, which is common to all pages, is generated using the vector font (outline font), the composite image data to the second sheet and so on can be generated at a high speed by combining generated fixed additional data with the original image data, although the processing somewhat takes a time at the start of the outputting (printing) of the document (the printing of the first page). Consequently, the speeding up of image outputting (printing) can be also realized. Incidentally, in the case of outputting a plurality of copies, the first pages of the second and so on copies do not take time by storing rasterized fixed additional data.

Moreover, according to the present embodiment, the processing of preparing additional data in the intervals of continuously conveyed output sheets is enabled by generating the data of variable additional information, which varies by page, using the bitmap font, the data of which can be generated at a high speed. Thereby, it is possible to deal with high speed printing output.

Incidentally, in the present embodiment, although the image reading section 4 is exemplified as an image obtaining section, the image obtaining section is not limited to the image reading section 4. For example, a communication section capable of communicating with an external device may be provided as the image obtaining section, and additional information may be added to the image data transmitted from the external device.

Moreover, in the present embodiment, the case where the image processing apparatus 1 is a multi function peripheral (MFP) is exemplified, the image processing apparatus 1 is not limited to the MFP, but the image processing apparatus 1 may be various apparatus, such as a copier and a facsimile, capable of obtaining original image data, and of combining the obtained original image data with additional information to output the composite image data.

Moreover, in the present embodiment, the case where variable additional information is generated using bitmap data. But, because the variable additional information is composed of predetermined character strings, such as a figure and a mark, the basic data of character information of the basis of the character strings constituting the variable additional information may be generated in advance using the vector font (outline font) to be stored (memorized) into the variable data region 20b.

For example, the bitmap data, which has a monospaced pitch, of the figures of from 0 to 9 is generated using the vector font (outline font) in advance, and the generated bit map data is previously stored (memorized) in the variable data region 20b. Then, if the “page number” is combined on the tenth sheet (tenth page) of an original image, then “1” and “0” are extracted from the bitmap data of the figures stored (memorized) in the variable data region 20b, and are combined with each other to generate the variable additional data of the page number “10.”

In this case, the variable data region 20b functions as the data storage section storing the basic data of the character information of the basis of the character strings constituting the variable additional information.

According to the configuration, basic data (the character information of the basis of character strings constituting the variable additional information, such as the figures of 0-9) is previously generated and stored in the data storage section to the variable additional information which varies by page. When the variable additional data is generated, necessary data is extracted from the previously stored basic data. Consequently, the configuration can deal with high speed printing output, and can produce high quality characters excellent in visual external appearance.

In addition, it is a matter of course that the present invention is not limited to the embodiment described above, but is suitably changeable.

What is claimed is:

1. An image processing apparatus comprising:
an image obtaining section to obtain original images to output original image data thereof;
a fixed data generating section to generate fixed additional data of a vector font corresponding to fixed additional information to be commonly added to each page of the original images, among additional information to be added to the original image data;
a fixed data storage section to store the fixed additional data generated by the fixed data generating section;
a variable data generating section to generate variable additional data corresponding to variable additional information which varies by page of the original images, among the additional information to be added to the original image data;
an image combining section to combine the fixed additional data and the variable additional data with the original image data to generate composite image data per page of the original images; and
an image forming section to form images based on the composite image data generated by the image combining section.

2. The image processing apparatus of claim 1, wherein the variable data generating section generates the variable additional data of a bitmap font.

3. The image processing apparatus of claim 1, further comprising a data storage section to store previously generated basic data, wherein
the variable data generating section extracts basic data corresponding to the variable additional information from the basic data stored in the data storage section, so as to generate the variable additional data.

4. An image processing method comprising the steps of:
an image obtaining step to obtain original images to output original image data thereof;
a fixed data generating step to generate fixed additional data of a vector font corresponding to fixed additional information to be commonly added to each page of the original images, among additional information to be added to the original image data;
a fixed data storing step to store the fixed additional data generated by the fixed data generating step;
a variable data generating step to generate variable additional data corresponding to variable additional information which varies by page of the original images, among the additional information to be added to the original image data;
an image combining step to combine the fixed additional data and the variable additional data with the original image data to generate composite image data per page of the original images; and
an image forming step to form images based on the composite image data generated by the image combining step.

5. The image processing method of claim 4, wherein in the variable data generating step, the variable additional data of a bitmap font is generated.

6. The image processing method of claim 4, further comprising a data storage step to store previously generated basic data, wherein
in the variable data generating step, basic data corresponding to the variable additional information is extracted from the basic data stored in the data storage section, so that the variable additional data is generated.

7. A computer-readable medium embodying a program which causes a computer to realize the functions of:
an image obtaining function to obtain original images to output original image data thereof;
a fixed data generating function to generate fixed additional data of a vector font corresponding to fixed additional information to be commonly added to each page of the original images, among additional information to be added to the original image data;
a fixed data storing function to store the fixed additional data generated by the fixed data generating function;
a variable data generating function to generate variable additional data corresponding to variable additional information which varies by page of the original images, among the additional information to be added to the original image data;
an image combining function to combine the fixed additional data and the variable additional data with the original image data to generate composite image data per page of the original images; and
an image forming function to form images based on the composite image data generated by the image combining function.

8. The computer-readable medium of claim 7, wherein in the variable data generating function, the variable additional data of a bitmap font is generated.

9. The computer-readable medium of claim 7, further comprising a data storage function to store previously generated basic data, wherein
in the variable data generating function, basic data corresponding to the variable additional information is extracted from the basic data stored in the data storage section, so that the variable additional data is generated.
